(19) United States
(12) Patent Application Publication
(10) Pub. No.: US 2007/0130968 A1
(43) Pub. Date: Jun. 14, 2007

(54) Refrigerating storage cabinet and refrigerating equipment

(76) Inventors: Shinichi Kaga, Toyoake-shi (JP); Akihiko Hirano, Toyoake-shi (JP); Takao Nakashima, Toyoake-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/575,467

(22) PCT Filed: Oct. 18, 2004
(86) PCT No.: PCT/JP04/15364

§ 371 Date: Apr. 12, 2006

(30) Foreign Application Priority Data
Oct. 17, 2003 (JP) 2003-357588
Feb. 25, 2004 (JP) 2004-049623

(51) Int. Cl. G05D 23/32; F25D 21/00; F25D 11/02

(52) U.S. Cl. 62/157; 62/150; 62/441

(57) ABSTRACT

A refrigeration unit 30 is made so as to correspond to refrigeration specifications of both refrigeration and freezing. Both refrigeration and freezing programs Px and Py are stored in a control 45 of each refrigeration unit 30. The refrigerating program Px is initially set to be executable. A pressure sensor 51 is mounted on a unit mount 38 of each refrigeration unit 30. A presser 52 is mounted only on the upper side of a ceiling of the freezing compartment 16. When the refrigeration unit 30 (unit mount 38) is mounted on the freezing compartment 16, the pressure sensor 51 is pressed by the presser 52 and switched on, so that the refrigerating program Py is selected. At the side of the refrigerating compartment 15, the pressure sensor 51 remains off even when the refrigeration unit 30 has been mounted. Accordingly, the refrigerating program Px is kept selected.

### TECHNICAL FIELD

The present invention relates to refrigerating storage cabinets and refrigeration equipment.

### BACKGROUND ART

Refrigerators-freezers for commercial use include a body comprising a heat insulating housing and also having heat insulating walls partition an interior into a freezing compartment and a refrigerating compartment. An atmosphere in the freezing compartment is refrigerated to about −20° C., whereas an atmosphere in the refrigerating compartment is refrigerated to about +5° C. For example, household refrigerators-freezers are provided with a single refrigeration unit and employ a refrigerating manner of distributing a part of the cold air circulating through the freezing compartment into the refrigerating compartment. However, refrigerators-freezers for commercial use have a larger capacity. In particular, when a refrigerating compartment has a large capacity, there is a noticeable reduction in the refrigerating efficiency. Accordingly, refrigerators-freezers for commercial use are respectively provided with refrigeration units for refrigeration and freezing purposes (for example, see patent document 1).

### DISCLOSURE OF THE INVENTION

### Problem to be Overcome by the Invention

When two refrigeration units used for refrigeration and for freezing are standardized, problems can be greatly reduced in design, manufacture, and control of the refrigerators-freezers. Accordingly, standardization is enormously useful. The inventors therefore pursued the development of a refrigeration unit usable for both refrigeration and freezing, and have recently completed the refrigeration unit.

On the other hand, a refrigeration unit is mounted on a heat insulating housing and then operated on the basis of a predetermined program, particularly in refrigerator-freezers for commercial use. The refrigeration units for refrigeration and for freezing differ in temperature settings and accordingly, in the timing of defrosting operations and the like. As a result, the refrigeration units are generally respectively operated on the basis of different programs.

Consequently, a program for refrigeration is stored in the control means for refrigeration whereas a program for freezing is stored in the control means for freezing. However, it is inefficient to store individual programs when the refrigeration units have been standardized. Furthermore, when two refrigeration units are delivered, separate from the body, to a mounting site, as in the refrigerator-freezer, there is a possibility that the refrigeration units, with programs for refrigeration and freezing, may respectively be erroneously conversely mounted on the freezing compartment and the refrigerating compartment, since the standardized refrigeration units are difficult to visually distinguish from each other.

The present invention was made in view of the foregoing circumstances.

### MEANS FOR OVERCOMING THE PROBLEM

The invention of the first aspect is refrigeration equipment provided with a refrigeration unit that includes a compressor, a condenser, an expanding mechanism, and an evaporator, and that has such a refrigerating performance as to meet a plurality of refrigerating specifications. The refrigeration unit can be controlled based on individual programs corresponding to refrigerating specifications. The refrigeration unit is characterized by a control means storing a desired one of the programs of the refrigerating specifications and being capable of executing said one program.

The invention of the second aspect is characterized in that in the refrigeration equipment according to the first aspect, the control means stores all of the refrigerating specification programs and is capable of executing a desired one of the programs.

The invention of the third aspect is a refrigerating storage cabinet in which a heat insulating housing is provided with a refrigeration unit that includes a compressor, a condenser, an expanding mechanism, and an evaporator. In addition, the refrigeration unit has such a refrigerating performance as to meet a plurality of refrigerating specifications. The refrigeration unit can be controlled based on individual refrigerating specification programs, and is characterized by a control means storing a desired one of the refrigerating specification programs and being capable of executing said one program.

The invention of the fourth aspect is characterized in that in the refrigerating storage cabinet according to the third aspect, the control means stores all of the refrigerating specification programs and is capable of executing a desired one of the programs.

The invention of the fifth aspect is characterized in that in the refrigerating storage cabinet according to the third or fourth aspects, the heat insulating housing has an opening in which a condensation-preventing heater is provided with variable heating performance. In addition, switching means is provided that is capable of switching the heating performance of the heater so that the heating performance corresponds to the refrigerating specification.

The invention of the sixth aspect is characterized in that in the refrigerating storage cabinet according to the fourth or fifth aspects, the refrigeration unit, provided with the control means, is detachably attachable to the heat insulating housing. In addition, identifying means is provided for identifying the refrigerating specification of the heat insulating housing to which the refrigeration unit is attached. The control means is capable of selecting and executing a corresponding one of the stored programs based on an identification signal from the identifying means.

The invention of the seventh aspect is characterized in that for the refrigerating storage cabinet according to the sixth aspect, two refrigerating specifications are provided. The identifying means includes a detecting portion provided at the side of the refrigeration unit and comprising means for detecting the presence or absence of a detected portion, provided at the side of the heat insulating housing, when the refrigeration unit is attached to the heat insulating housing.

The invention of the eighth aspect is characterized in that for the refrigerating storage cabinet according to the sixth aspect, the identifying means includes a set internal temperature input section, to which a set internal temperature of the heat insulating housing is input. The set internal temperature input section has the function of identifying the refrigerating specification based on the set internal temperature input.

The invention of the ninth aspect is characterized in that for the refrigerating storage cabinet according to the sixth aspect, the identifying means includes a signal recording section provided on the heat insulating housing, for recording an identification signal for the refrigeration specification. Additionally, the identifying means includes a reading section that is capable of reading the identification signal of the signal recording section and inputting the identification signal to the control means.

The invention of the tenth aspect is characterized in that for the refrigerating storage cabinets according to any one of the sixth through ninth aspects, the heat insulating housing is provided with an information recording section on which supplementary information, including a size of the heat insulating housing and a heat invasion amount characteristic, is recorded. In addition, information conveying means is provided for reading the information of the information recording section and conveying the information to the control means.

The invention of the eleventh aspect is characterized in that for the refrigerating storage cabinets according to any one of the third through tenth aspects, the refrigerating specifications include two refrigerating specifications for refrigeration and freezing.

The invention of the twelfth aspect is characterized in that for the refrigerating storage cabinets according to any one of the third through eleventh aspects, the refrigerating storage cabinet performs pull down cooling in which the internal atmosphere is refrigerated so that the internal temperature is decreased from a high temperature, higher than a set temperature, to near the set temperature. In addition, the refrigerating storage cabinet performs a control refrigeration in which when the internal temperature has risen to an upper limit temperature, higher by a predetermined value than the set temperature, the refrigeration unit is operated. Additionally, when the internal temperature has dropped to a lower limit temperature, lower by a predetermined value than the set temperature, the refrigeration unit is stopped. The refrigeration unit is repeatedly operated and stopped so that the internal temperature is kept about the set temperature. The program controls the operation of the refrigerating unit in each of the pull down cooling range and the control refrigeration range so that a physical amount with respect to refrigeration, including the internal temperature, is reduced following a refrigeration characteristic indicative of a time-varying change mode of dropping of the physical amount. A plurality of pull down cooling characteristics and/or a plurality of control refrigeration characteristics is provided. Each refrigeration characteristic is selectively read according to a condition or the like.

### EFFECT OF THE INVENTION

<The First Aspect of the Invention>

The refrigeration unit is configured to meet a plurality of refrigerating specifications that differ from each other in refrigeration temperature, for example, while a desired operation program, meeting the refrigerating specifications of the refrigeration equipment, is stored in the control means before the refrigeration unit is brought into operation. Consequently, a common refrigeration unit, including the control means, can be attached to refrigeration equipment having different refrigerating specifications. Standardization of the refrigeration unit can realize a large reduction in production costs.

<The Second Aspect of the Invention>

The refrigeration unit is configured to meet a plurality of refrigerating specifications that differ from each other in refrigeration temperature, for example, while all of the refrigerating specification operation programs are stored in the control means. A program meeting a desired refrigerating specification is made executable before the refrigeration unit is brought into operation. Consequently, a common refrigeration unit, including the control means, can be attached to refrigeration equipment having differing refrigerating specifications. Standardization of the refrigeration unit can realize a large reduction in production costs.

<The Third Aspect of the Invention>

The refrigeration unit is configured to meet a plurality of refrigerating specifications that differ from each other in an internal refrigeration temperature, while a desired one of operation programs, meeting the refrigerating specifications of the heat insulating housing, is stored until the refrigeration unit is brought into operation. Consequently, a common refrigeration unit, including the control means, can be attached to refrigerating storage cabinets with different refrigerating specifications.

<The Fourth Aspect of the Invention>

The refrigeration unit is configured to meet a plurality of refrigerating specifications that differ from each other in internal refrigeration temperature, while all of the refrigerating specification operation programs are stored in the control means. A program meeting a desired refrigerating specification is made executable before the refrigeration unit is brought into operation. Consequently, a common refrigeration unit, including the control means, can be attached to refrigeration equipment having differing refrigerating specifications.

<The Fifth Aspect of the Invention>

When the refrigeration unit is operated according to a predetermined refrigerating specification, the heating performance of a condensation-preventing heater is switched via switching means along with the selection of a program or by another operation, in order to be suitable for the refrigerating specification. Consequently, condensation can be reliably prevented without unnecessary power consumption.

<The Sixth Aspect of the Invention>

The refrigeration unit is configured to meet a plurality of refrigerating specifications that differ from each other in the internal temperature to be achieved by refrigeration. On the other hand, the operation programs of all of the refrigerating specifications are stored by the control means. The identifying means determines the refrigerating specification of the heat insulating housing upon the attachment of the refrigerating unit to the heat insulating housing. The control means is capable of selecting and executing a corresponding program based on the identification signal. Accordingly, a common refrigeration unit, including the control means, can be attached to each of the refrigerating storage cabinets having differing refrigerating specifications. Moreover, the program can accurately operate the refrigeration unit corresponding to each of the refrigerating specifications.

<The Seventh Aspect of the Invention>

When the refrigeration unit has been attached to the heat insulating housing, whether the detecting portion, on the side of the refrigeration unit, detects the detected portion identifies either one of the two refrigerating specifications for the heat insulating housing. Therefore, upon the attachment of the refrigeration unit it can be determined that the heat insulating housing has one or another of the two refrigerating specifications.

<The Eighth Aspect of the Invention>

The internal temperature is input to the identifying means after having been set. The refrigerating specification of the heat insulating housing is determined on the basis of the input value. The refrigerating specification of the heat insulating housing can automatically be set upon the required operation of setting the internal temperature.

<The Ninth Aspect of the Invention>

The reading section reads the identification signal on the signal recording section provided on the heat insulating housing, whereby the refrigerating specification of the heat insulating housing is determined.

<The Tenth Aspect of the Invention>

For example, the amount of air produced by an internal fan is controlled according to the size of the heat insulating housing, or the operation of the refrigeration unit is adjusted according to the characteristic heat invasion amount. Thus, a more accurate refrigerating control can be carried out according to the individual heat insulating housings.

<The Eleventh Aspect of the Invention>

A common refrigeration unit with the control means can be attached to both refrigerators and freezers. Moreover, the appropriate program, corresponding to either refrigeration or freezing, can accurately operate the refrigeration unit.

<The Twelfth Aspect of the Invention>

A plurality of pull down cooling characteristics and/or a plurality of control refrigeration characteristics is provided. Each refrigeration characteristic can be selectively read and executed according to a condition during the refrigerating operation or the like.

For example, the internal temperature can rise to a large degree during the operation of the refrigerator in the control refrigeration range when the door is frequently opened and closed or warm foodstuff is placed into a compartment of the refrigerator. In such a case, the refrigerator is switched for operation under a pull down cooling characteristic providing a large temperature drop. A normal pull down cooling characteristic with a relatively smaller degree of temperature drop is selected when the difference between the internal and external temperatures is not more than a predetermined value. On the other hand, when the difference exceeds the predetermined value, a pull down cooling characteristic is selected with a relatively larger degree of temperature drop. The foregoing arrangement is effective when a quick return to the normal temperature is desired under the conditions in which the internal temperature is shifted to a large degree from the pull down cooling characteristic range.

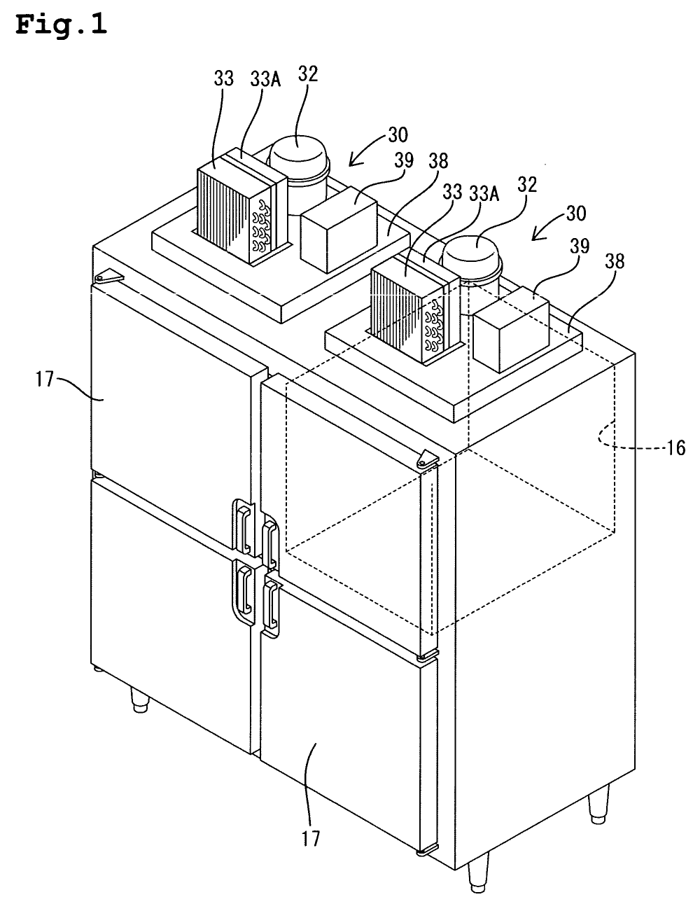

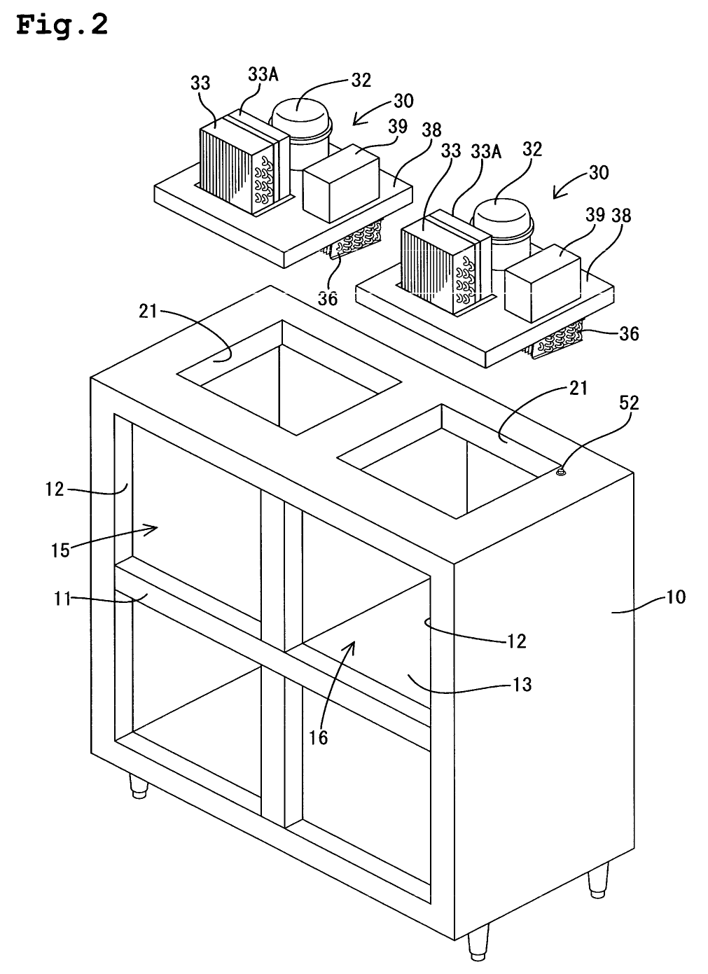

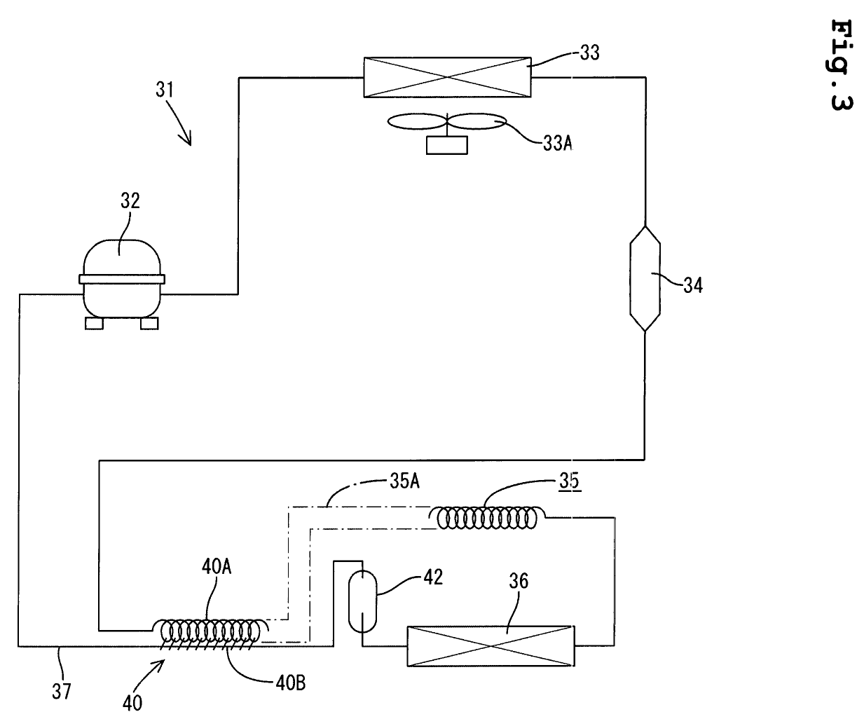

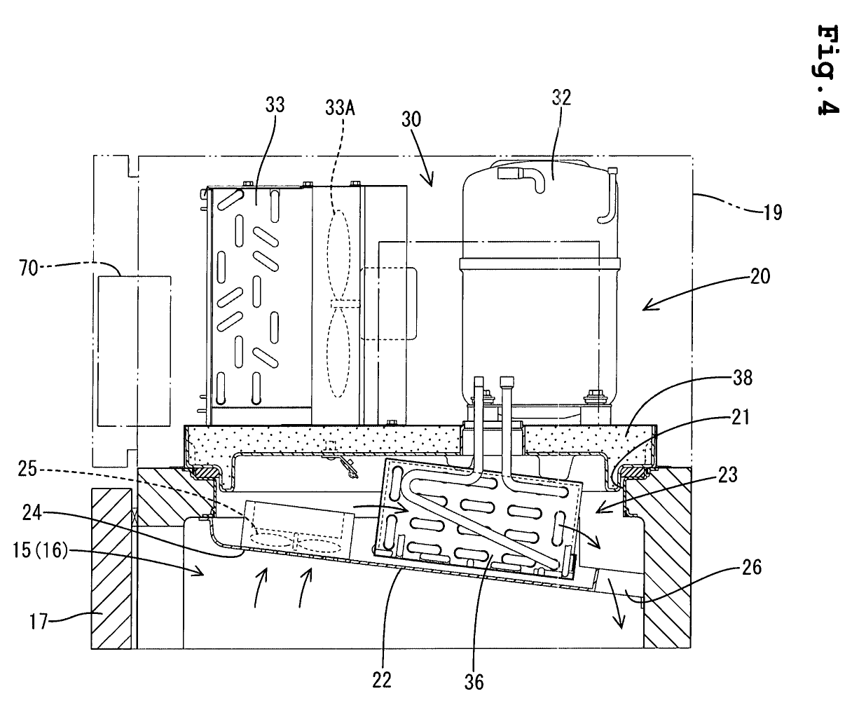

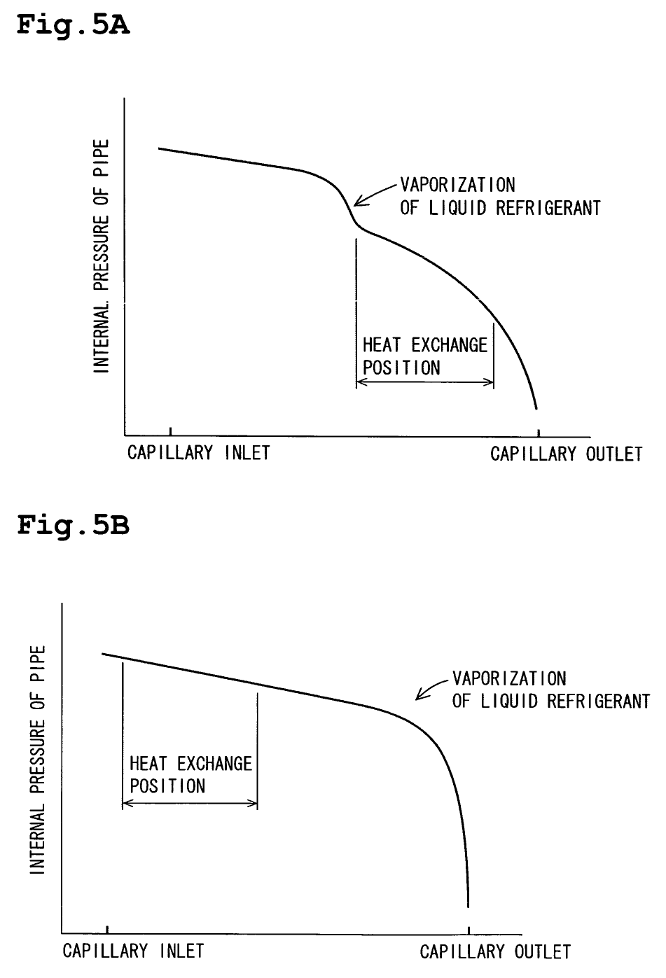

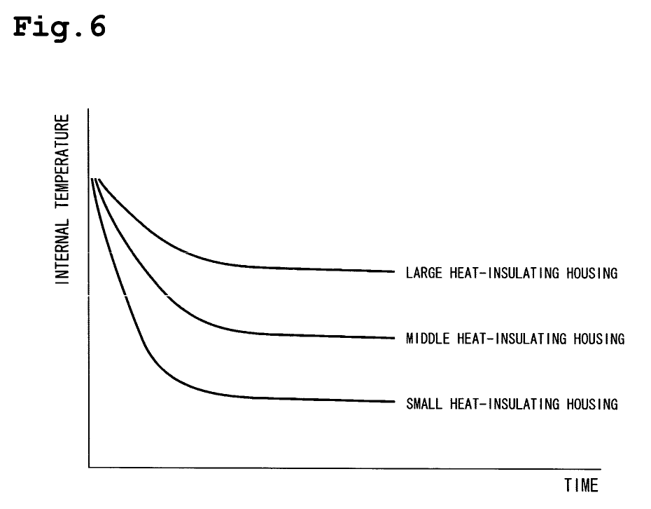

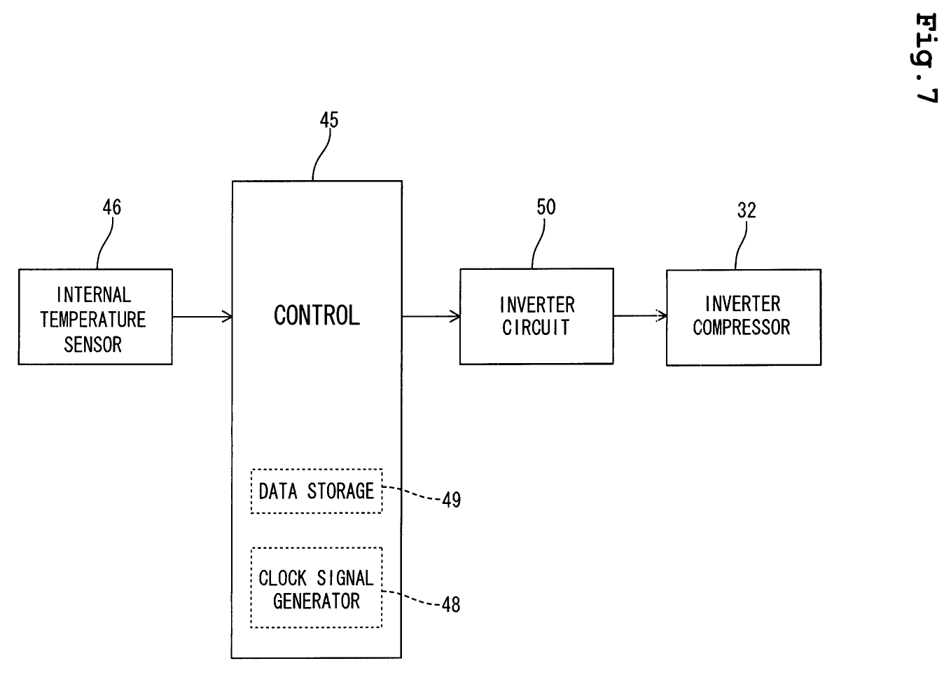

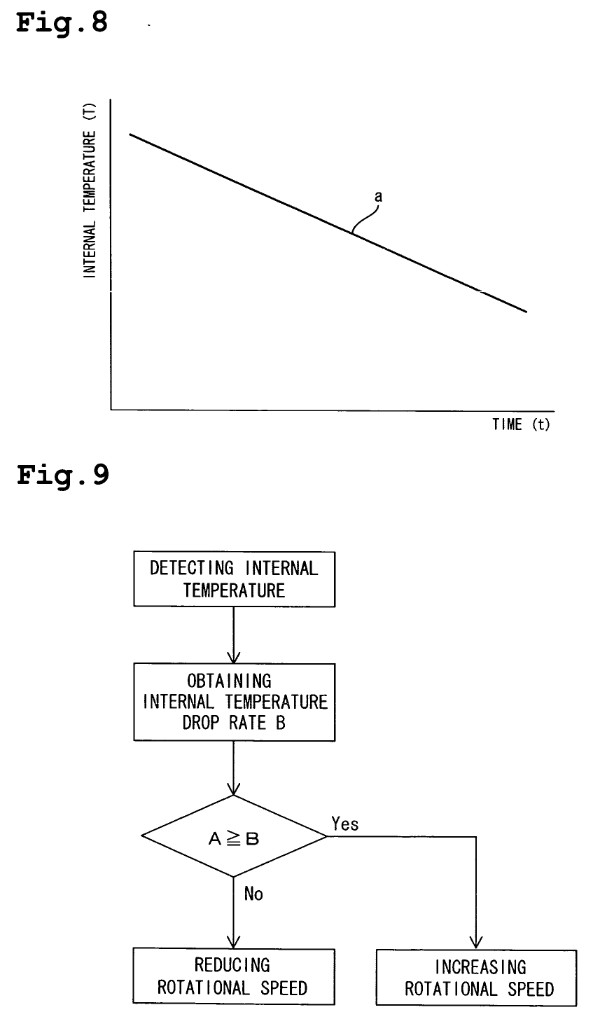

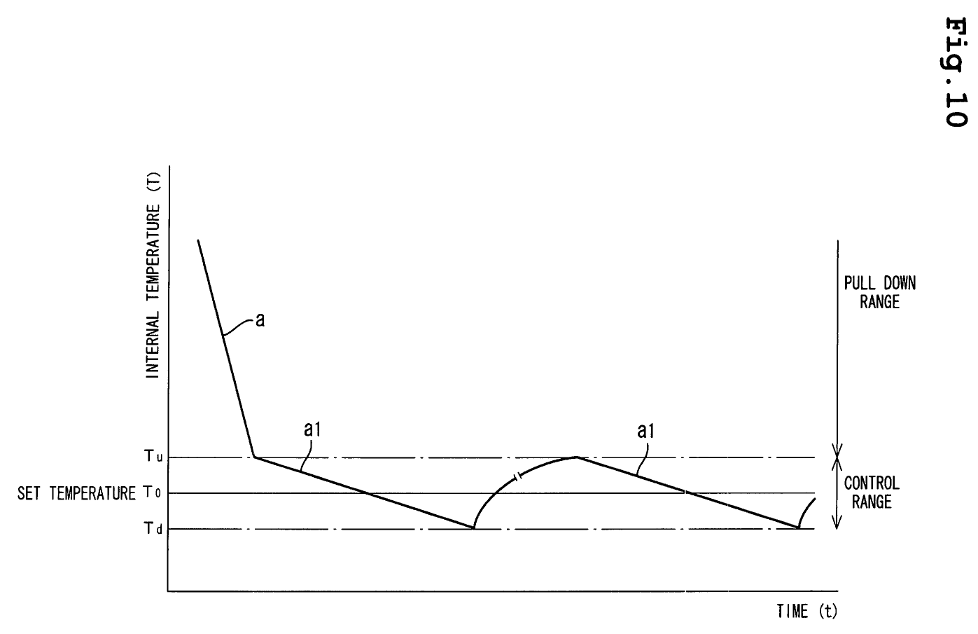

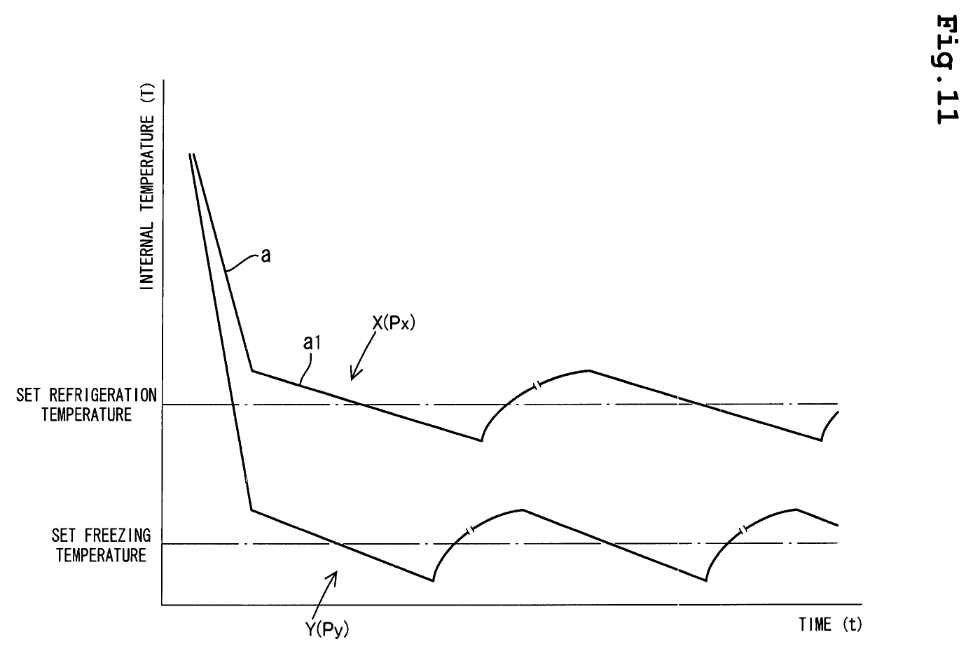

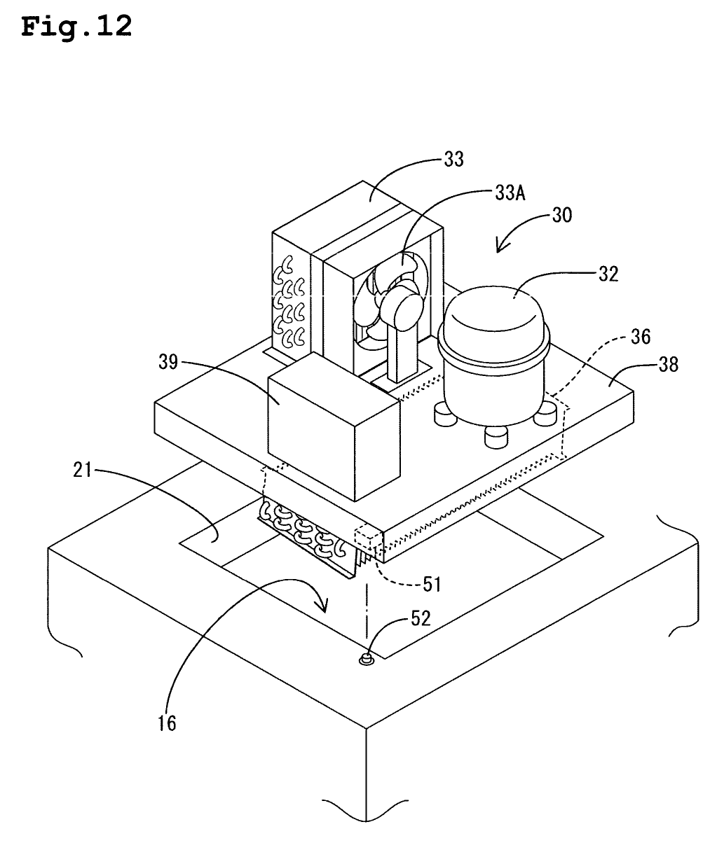

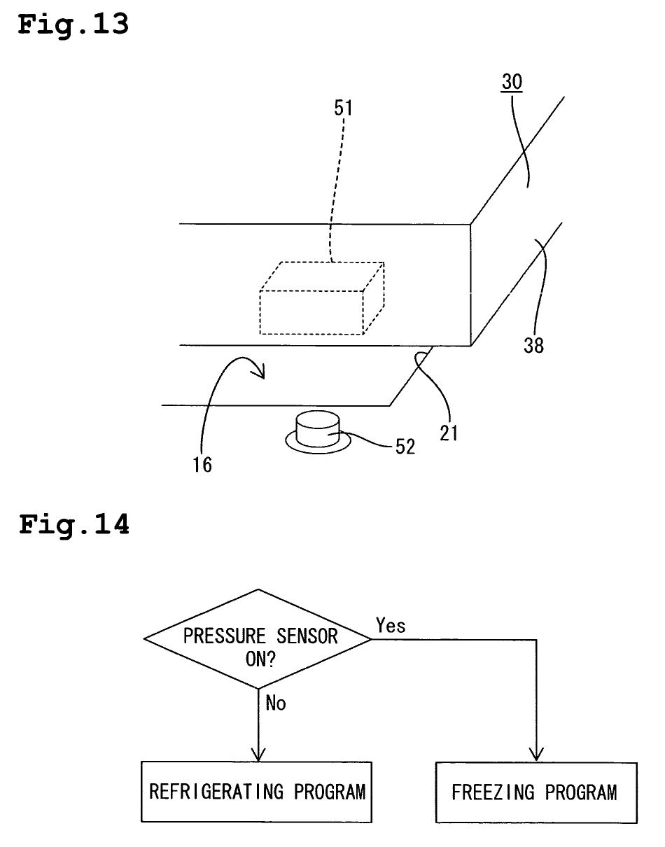

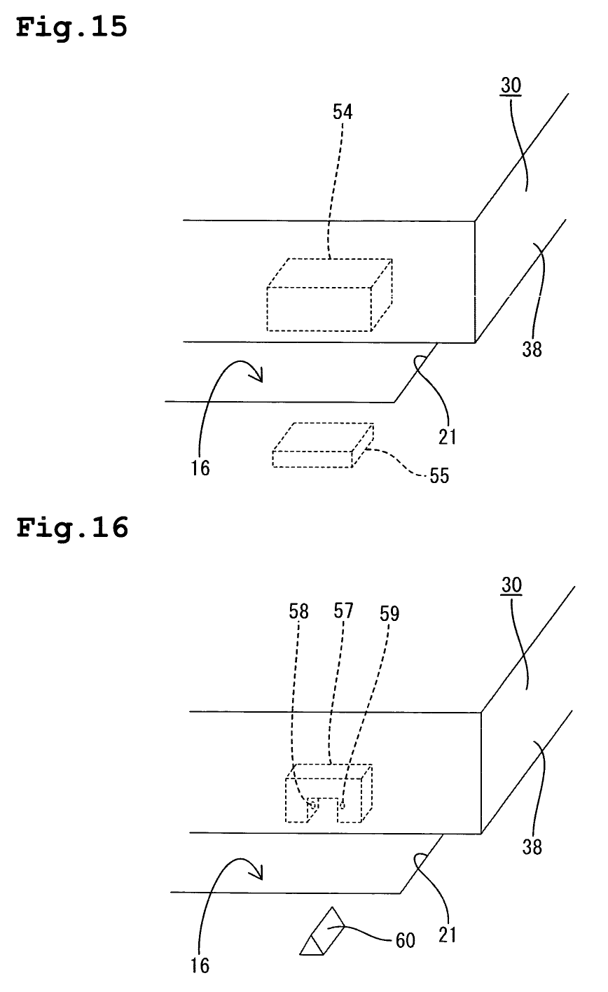

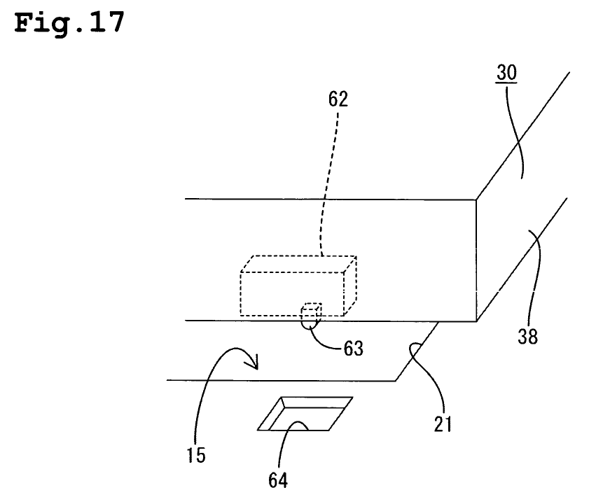

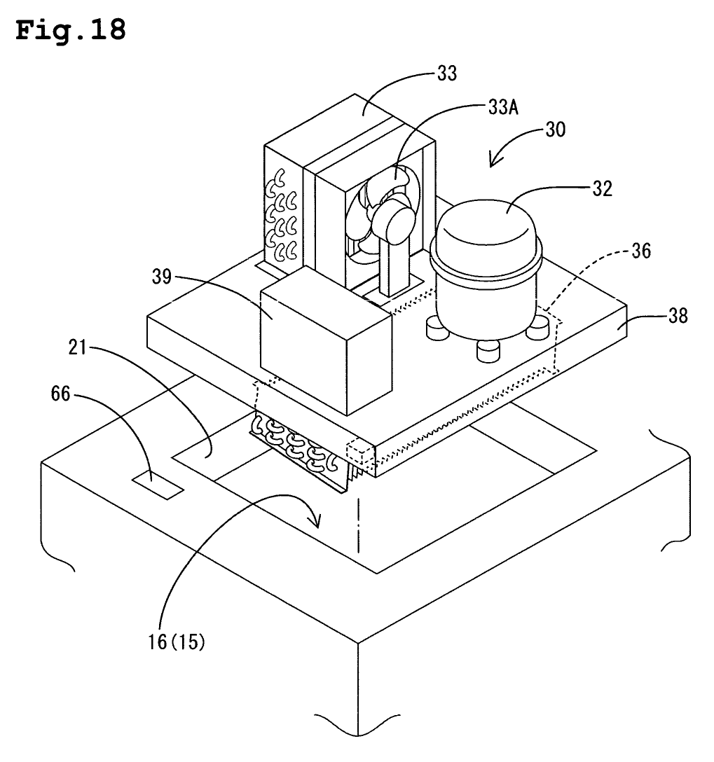

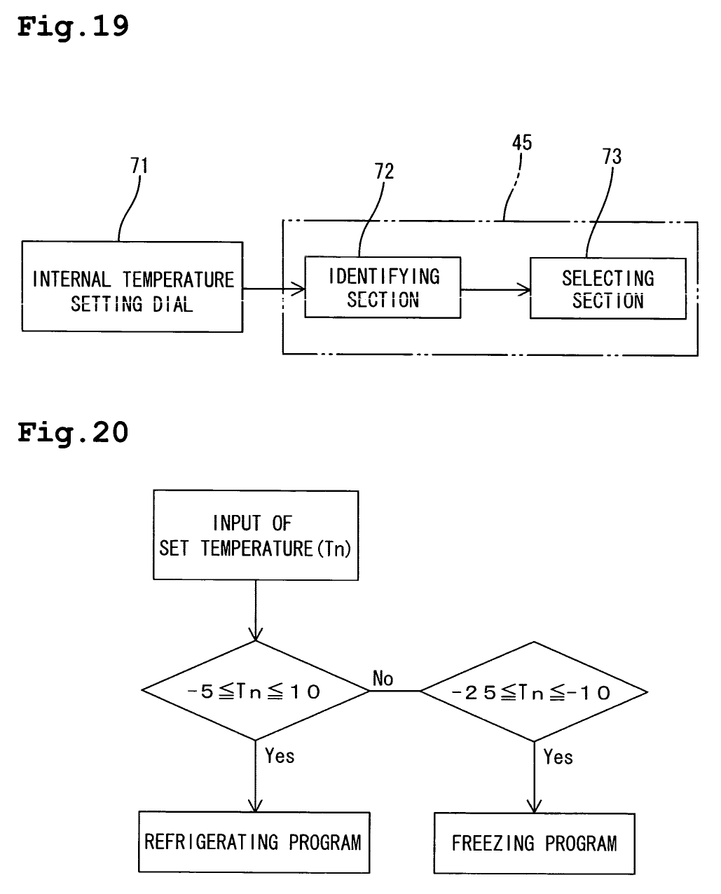

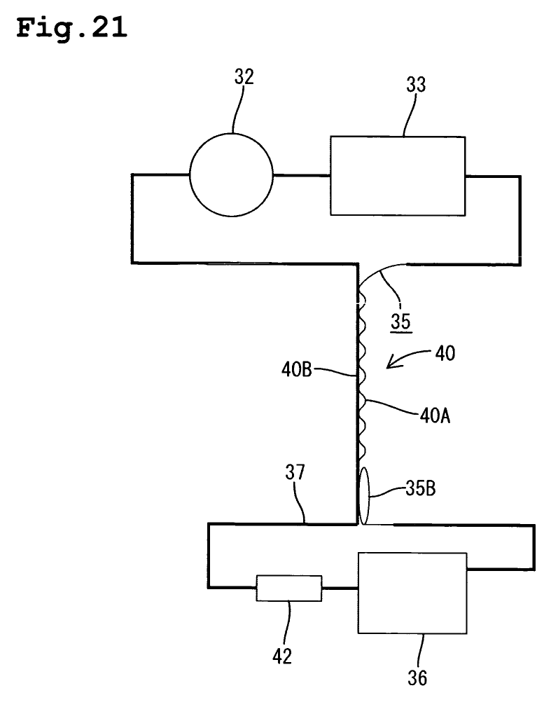

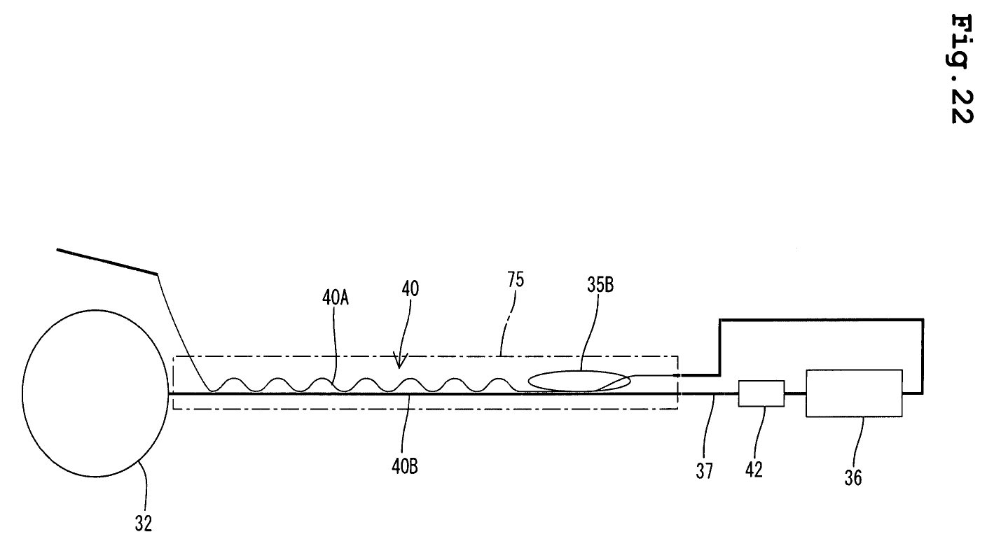

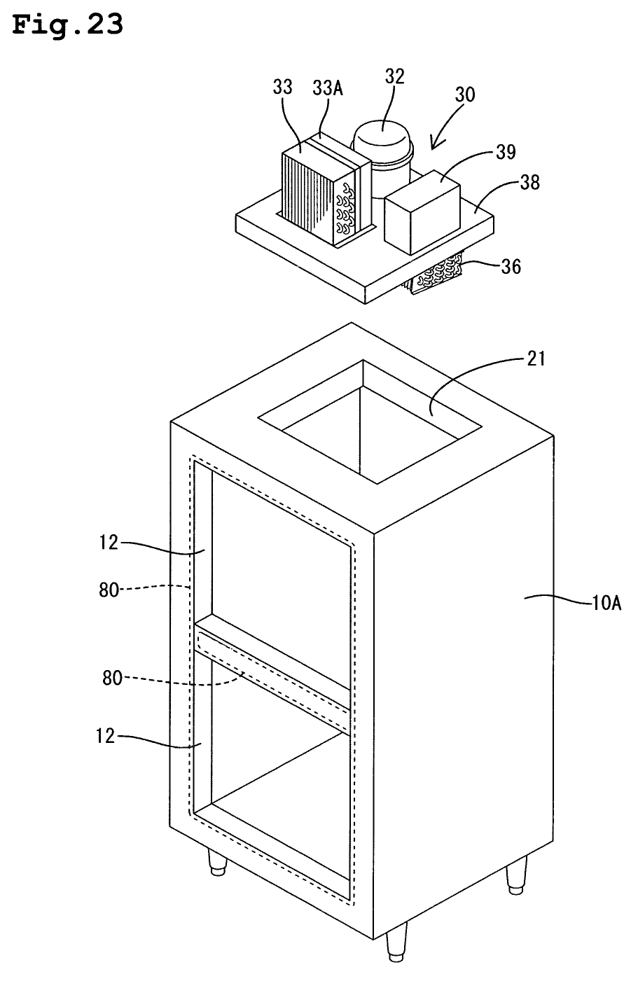

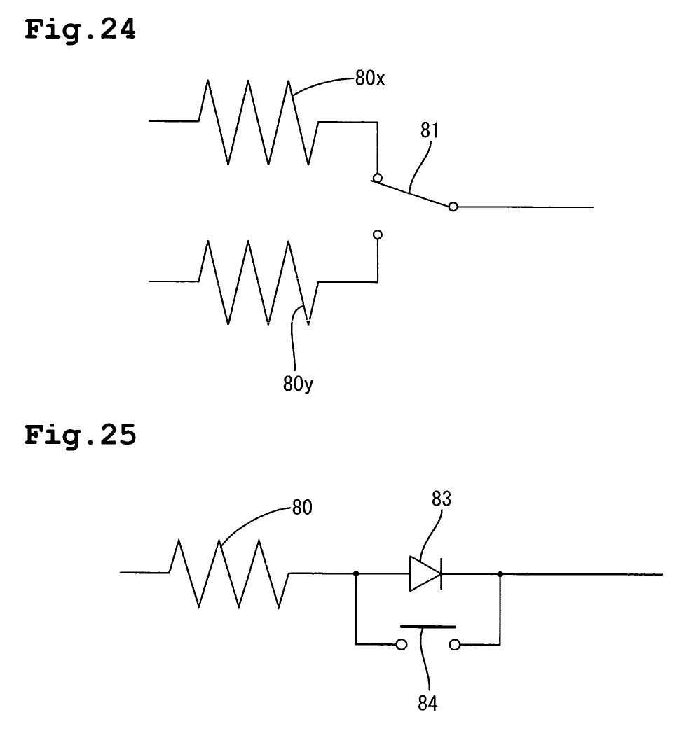

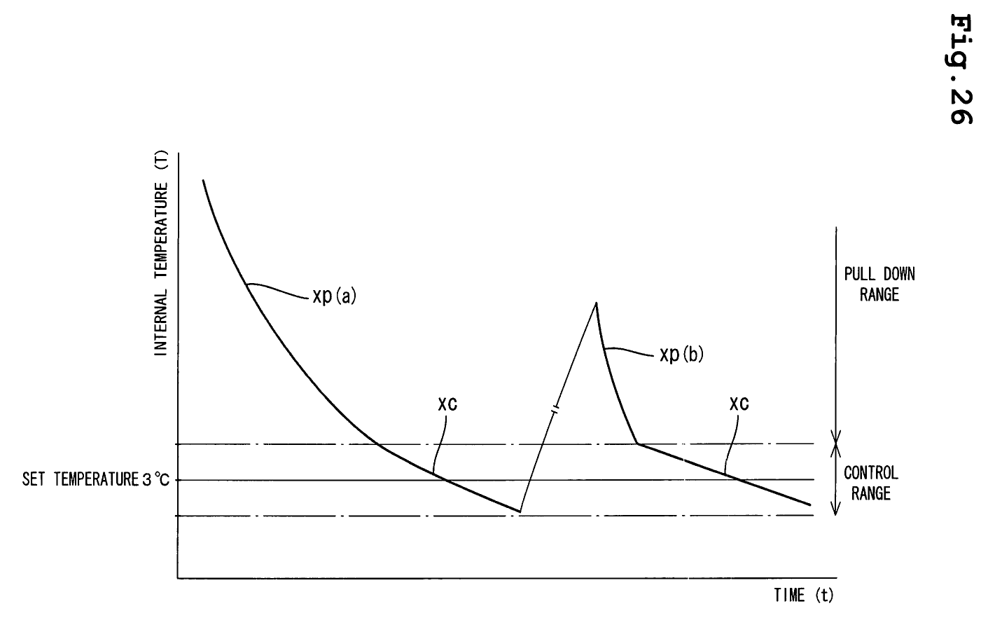

### BRIEF DESCRIPTION OF THE DRAWINGS

[FIG. 1] A perspective view of a refrigerator-freezer in accordance with embodiment 1 of the present invention;

[FIG. 2] An exploded perspective view of the refrigerator-freezer;

[FIG. 3] A refrigerating circuit diagram;

[FIG. 4] A partial section of the refrigerator-freezer in which a refrigeration unit is mounted;

[FIG. 5] Graphs showing pressure changes in a capillary tube;

[FIG. 6] A graph showing temperature curves in pull down cooling ranges;

[FIG. 7] A block diagram of a control mechanism of an inverter compressor;

[FIG. 8] A graph showing an ideal temperature curve under pull down cooling;

[FIG. 9] A flowchart showing the control of the inverter compressor;

[FIG. 10] A graph showing a temperature curve in a control refrigeration range;

[FIG. 11] A graph showing internal temperature characteristics on the refrigeration side and on the freezing side for the purposes of comparison;

[FIG. 12] An exploded perspective view of the ceiling of a freezing compartment;

[FIG. 13] A partial exploded perspective view of identifying means;

[FIG. 14] A flowchart showing the function of a selector;

[FIG. 15] A partial exploded perspective view of an identifying unit of modified form 1;

[FIG. 16] A partial exploded perspective view of an identifying unit of modified form 2;

[FIG. 17] A partial exploded perspective view of an identifying unit of modified form 3;

[FIG. 18] A partial exploded perspective view of the refrigerator-freezer in which a refrigeration unit is mounted, in embodiment 2 of the present invention;

[FIG. 19] A block diagram showing embodiment 3 of the present invention;

[FIG. 20] A flowchart showing operation of embodiment 3;

[FIG. 21] A refrigerating circuit diagram in embodiment 4;

[FIG. 22] A partially enlarged view of the circuit of FIG. 21;

[FIG. 23] An exploded perspective view of refrigerating storage in accordance with embodiment 5;

[FIG. 24] A circuit diagram of a switching portion of a condensation-preventing heater;

[FIG. 25] A circuit diagram of a modified form of embodiment 5; and

[FIG. 26] A graph showing a manner of refrigeration control in embodiment 6.

### EXPLANATION OF REFERENCE SYMBOLS

Px . . . refrigerating program, Py . . . freezing program, 10 . . . body, 12 . . . access opening (opening), 15 . . . refrigerating compartment, 16 . . . freezing compartment, 21 . . . opening, 30 . . . refrigeration unit, 31 . . . freezing circuit, 32 . . . inverter compressor (compressor), 33 . . . condenser, 35 . . . capillary tube (expansion mechanism), 36 . . . evaporator, 38 . . . unit mount, 39 . . . electrical component box, 45 . . . control section (control means), 51 . . . pressure sensor (detecting section), 52 . . . presser (detected portion), 54 . . . reed switch (detecting section), 55 . . . magnet (detected portion), 57 . . . photo sensor (detecting section), 60 . . . shading protrusion (detected section), 62 . . . micro switch (detecting section), 64 . . . recess (detected portion), 66 . . . information recording section, 71 . . . internal temperature setting dial (internal set temperature input portion), 72 . . . identifying portion, 73 . . . selecting portion, 10A . . . body, 80, 80x, and 80y . . . condensation-preventing heater, and 81 and 84 . . . switching relay (switching means).

### BEST MODE FOR CARRYING OUT THE INVENTION

Embodiments of the present invention will be described with reference to the attached drawings.

### Embodiment 1

Embodiment 1 will be described with reference to FIGS. 1 to 14. In this embodiment the invention is applied to a refrigerator-freezer for commercial use.

The refrigerator-freezer is a four-door type refrigerator-freezer and is provided with a body 10, comprising a heat insulating housing having an open front, as shown in FIGS. 1 and 2. A cruciform partition frame 11 partitions the open front into four access openings 12. Heat insulating walls 13 partition substantially a quarter of the inner space, corresponding to an upper right access opening 12, as viewed from the front, thereby forming the inner space into a freezing compartment 16. The remaining three quarters of the inner space serve as a refrigerating compartment 15. Heat insulating doors 17 are pivotally mounted so as to respectively close and open the access openings 12.

An equipment compartment 20 is defined on the top of the body 10 by a panel 19 (see FIG. 4), extending around the top of the body 10. Square openings 21, having the same size, are formed in the top of the body 10 (also serving as the bottom of the equipment compartment 20), so as to respectively correspond to ceilings of the refrigerating and freezing compartments 15 and 16. Refrigeration units 30 are respectively adapted to be individually mounted in the openings 21.

Referring to FIG. 3, each refrigeration unit 30 includes a freezing circuit 31 formed by connecting a compressor 32, a condenser 33 with a condenser fan 33A, a drier 34, a capillary tube 35, and an evaporator 36, to one another in a closed loop using refrigerant piping 37, as will be described in detail later. Furthermore, a heat insulating unit mount 38 is mounted so as to close the openings 21. The evaporator 36, a component of the refrigeration unit 30, is mounted on the lower side of the unit mount 38. However, the other components of the refrigeration unit 30 are mounted on the upper side of the unit mount 38.

Conversely, a drain pan 22, which also serves as a refrigerating duct, is located on the ceilings of the refrigerating and freezing compartments 15 and 16 and is inwardly inclined downward. An evaporator compartment 23 is defined between the unit mount 38 and the drain pan 22, as shown in FIG. 4. The drain pan 22 has an inlet port 24 formed in the upper side thereof. The refrigerating fan 25 is mounted on the upper side of the drain pan 22. The drain pan 22 further has an outlet port 26 formed in a lower side thereof.

Upon the operation on of the refrigeration unit 30 and the refrigerating fan 25, basically, air in the refrigerating compartment 15 (the freezing compartment 16) is absorbed through the inlet port 24 into the evaporator compartment 23, as shown by the arrows in FIG. 4. The air is altered into chilled air by an exchange of heat while passing through the evaporator 36. The chilled air is discharged through the outlet port 26 into the refrigerating compartment 15 (the freezing compartment 16), whereby the chilled air is circulated so that the atmosphere is refrigerated in the refrigerating compartment 15 (the freezing compartment 16).

In the embodiment, the intention is for the refrigeration units 30, provided for the refrigerating and freezing compartments 15 and 16, to be standardized. The following measures are taken for this purpose.

Firstly, the refrigerating performance of the refrigeration unit 30 depends upon the capacity of a compressor. For example, when the same type of compressor is used, a volume refrigerated on the freezing side, where the evaporating temperature is lower, is smaller than a volume refrigerated on the refrigerating side. Furthermore, a larger volume for either the refrigerating or freezing compartments necessitates a larger refrigerating performance level.

More specifically, the required refrigerating performance level differs depending upon conditions of distinction such as between refrigeration and freezing, or the volume of a compartment. Accordingly, an inverter compressor 32 is used that has a required maximum capacity and a controllable rotational speed.

Secondly, a common capillary tube 35 is used. The capillary tube 35 corresponds to the portion from the exit of the drier 34 to the inlet port of the evaporator 36, as shown in FIG. 3. The capillary tube 35 includes a central helical part 35A that is provided for increasing the effective length of the tube. The whole length of the capillary tube 35 is set at 2000 mm to 2500 mm in this embodiment. The refrigerant piping 37 extends from the exit of the evaporator 36 to an inlet of the inverter compressor 32. Additionally, the refrigerant piping 37 has a length of about 700 mm. Conventionally, a capillary tube for refrigeration has high flow characteristics and a capillary tube for freezing has low flow characteristics. In this embodiment however, the capillary tube 35 has intermediate flow characteristics between refrigeration and freezing.

A capillary tube suitable for refrigeration has such flow characteristics that an internal equilibrium temperature, at which the freezing performance of the refrigeration unit balances the thermal load of the heat insulating housing, ranges from about 0° C. to about −10° C. when the refrigeration unit, assembled with the heat insulating housing, is operated at room temperature. Furthermore, a capillary tube suitable for freezing has such flow characteristics that an internal equilibrium temperature ranges from about −15° C. to about −25° C. Accordingly, a capillary tube with intermediate flow characteristics between refrigeration and freezing has such flow characteristics that an internal equilibrium temperature ranges from about −10° C. to about −20° C. when the refrigeration unit is operated under the same conditions as previously described.

When the capillary tube 35 has the intermediate flow characteristics previously described, there is a concern that the flow rate of liquid refrigerant would be insufficient in the refrigeration region. The following measures are taken in order to resolve that concern.

In this type of freezing circuit, the refrigerant piping 37 at the exit side of the evaporator 36 and the capillary tube 35 are soldered together, thereby forming into a heat exchanger 40. As a result, the general evaporating performance is improved and mist-like liquid refrigerant, which cannot be evaporated by the evaporator 36, is vaporized, for example. In this embodiment, when the heat exchanger 40 is formed between the capillary tube 35 and the refrigerant piping 37, a heat exchanging portion 40A on the side of the capillary tube 35 is set at a predetermined area on an upstream side end of the helical portion 35A. The heat exchanging portion 40A is located at a position nearer to the entrance side of the capillary tube 35.

The capillary tube 35 has a large pressure difference between the inlet and outlet thereof. As shown in FIG. 5A, the flow resistance is adapted to suddenly increase at a part of the capillary tube 35 where the liquid refrigerant starts to vaporize in the piping (approximately a central part), and the pressure largely drops from this part to the downstream side (outlet side). The heat exchange section of the capillary tube 35 is conventionally set at a position nearer to the second half of the whole length of the capillary tube and rather nearer to the outlet of the capillary tube. As a result, heat exchange is carried out even after evaporation (vaporization) starts in the piping. The reason for this is that since the capillary tube 35 is cooled on the downstream side from the heat exchange position and accordingly causes dew condensation and rust, the heat exchange position is located as close as possible to the outlet side so that a length of an exposed portion in the refrigerated state is restrained.

In this embodiment however, the position of the heat exchanging portion 40A of the capillary tube 35 is set close to the inlet. Specifically, the heat exchanging portion 40A is located before the position where the liquid refrigerant starts vaporizing. As a result, excessive cooling is increased such that the boiling start point in the piping can be shifted to the downstream side of the capillary tube 35, as shown in FIG. 5B. This results in a reduction in the total resistance of the capillary tube 35 whereupon the flow rate of the liquid refrigerant is substantially increased. Consequently, the problem of an insufficient flow rate of liquid refrigerant can be overcome when a capillary tube 35, having intermediate flow rate characteristics, is used for the refrigerating region.

The heat exchanging portion 40A of the capillary tube 35 is located before the position where the liquid refrigerant starts vaporizing, and at least in the first half region of the whole length of the capillary tube 35. This is in order that the above-mentioned boiling start point in the piping may be shifted to the downstream side of the capillary tube 35. More preferably, the heat exchanging portion 40A is located within a one third region at the inlet side (the region where an amount of refrigerant in the liquid state is large).

Furthermore, when the heat exchanging portion 40A of the capillary tube 35 is provided at a position close to the inlet, the subsequent longer portion is exposed in the cooling state. Accordingly, the portion is desired to be spaced as far away as possible from the refrigerant piping 37 and covered with a heat-insulating tube (not shown). Consequently, dew condensation and rust can be prevented.

On the other hand, an accumulator 42 (a liquid separator) is provided immediately to the rear of the evaporator 36 with regard to the insufficiency of the throttle in the freezing region, when the capillary tube 35 has intermediate flow characteristics. The accumulator 42 provides an adjustment capacity for storing liquid refrigerant in the refrigerating circuit 31.

The refrigerant pressure in the evaporator 36 is lower in the freezing range (the evaporating temperature of the refrigerant is low) and the density of refrigerant gas is low as compared with the pull down cooling range (the range of quick refrigeration) or the refrigeration range. Accordingly, since the amount of refrigerant to be circulated by the compressor 32 is small, there is an excess of liquid refrigerant in the freezing circuit 31. However, since the excess liquid refrigerant is stored in the accumulator 42, the excess liquid refrigerant can be prevented from flowing into the capillary tube 35 or the like. Consequently, the capillary tube 35 has the substantial effect of throttling the flow rate. Thus, insufficiency in the throttle can be overcome when the capillary tube 35 has intermediate flow characteristics.

Regarding the standardization of the capillary tube 18, when the capillary tube 35 has intermediate flow rate characteristics and the accumulator 42 is provided directly behind the outlet of the evaporator 36 in order to achieve the throttling effect for a reduction in the flow rate of the liquid refrigerant, the capillary tube 35 is adapted to the freezing range with a low flow rate. In addition, the heat exchanging portion 40A of the capillary tube 35 is located at the side nearer to the inlet so that the total resistance in the piping is reduced, whereby the flow rate of the liquid refrigerant is increased. More specifically, the capillary tube 35 is adapted to the pull down cooling range and the refrigeration range with a high flow rate.

When the accumulator 42 is provided at the downstream side of the heat exchanging portion 40A of the refrigerant piping 37, there is a possibility that the refrigerant may flow into the heat exchanging portion 40A in a mixed gas-liquid state. In such a case, the liquid refrigerant evaporates. In other words, the execution by the evaporator 36 of the evaporation of the liquid refrigerant is instead carried out by the heat exchanging portion 40A as excess work. This leads to a reduction in refrigerating performance in the freezing circuit 1.

In this embodiment however, the accumulator 42 is provided directly behind the outlet of the evaporator 36. Specifically, the accumulator 42 is provided at the upstream side of the heat exchanging portion 40B of the refrigerant piping 37. Accordingly, since only gas refrigerant flows into the heat exchanging portion 40B, excessive evaporation is not. Therefore, the intrinsic refrigerating performance of the freezing circuit 31 can be ensured.

Furthermore, the heat exchanging portion 40A is set at the side nearer to the inlet of the capillary tube 35. As a result, there is a concern that the flow rate of liquid refrigerant may also be increased at the freezing side. However, this concern may be overcome as follows.

In the refrigerating circuit 31 with the capillary tube 35, the high-pressure side and the low-pressure side basically share the refrigerant. Conceptually, the refrigerant is in the condenser 33 and the evaporator 36 in the refrigeration range (including the pull down cooling range). Whereas, a large amount of refrigerant is in the evaporator 36 and accumulator 42 and a small amount of refrigerant is in the condenser 33. As a result, the refrigerant enters into the capillary tube 35 as a completely liquid flow in the refrigerating range. However, since the refrigerant flows in a mixed gas-liquid state in the freezing range, the flow rate of the refrigerant is reduced. Consequently, even when heat exchange is carried out at a position near the inlet of the capillary tube 35 such that the excessive cooling occurs, the flow rate of the refrigerant is not drastically increased.

On the contrary, as the result of the provision of the accumulator 42 there is a possibility that the flow rate may be reduced in the refrigeration range (including the pull down cooling range). For a reason opposite to the reason previously provided, the compressor 32 circulates a large amount of refrigerant in the refrigeration range (including the pull down cooling range). Accordingly, the amount of excess liquid refrigerant in the freezing circuit 31 is small. Because of this, only a little amount of liquid refrigerant is stored in the accumulator 42. Therefore, it is considered that there is almost no possibility of a reduction in the flow rate.

As described above, the refrigeration units 30 employ a structure common for refrigeration and freezing. On the other hand, the refrigeration units 30 are individually controlled in operation. This is based on the perception that a temperature characteristic in pull down cooling changes to a large extent depending upon conditions such as the division between refrigeration and freezing, or the internal capacity.

A refrigeration unit provided with an inverter compressor performs at the highest allowable operating speed in pull down cooling. Large, middle, and small, heat insulating housings present clear differences among internal temperatures when pull down cooling is carried out under identical conditions in which no food is stored in the compartments, as shown in FIG. 6. The reason for this is that the difference in the degree of temperature drop is proportional to the surface area of the heat insulating housing when the difference in the internal and external temperatures is the same. Additionally, the heat capacity of an internal wall material or rack is large as the box becomes larger.

On the other hand, greater importance is put on a temperature characteristic of pull down cooling in refrigerators-freezers for commercial use. For example, refrigeration starting from a high internal temperature, such as 20° C., is substantially limited to the initial operation after installation, re-operation several times after a power-off period for maintenance, several minutes of door opening in the storing of food materials, or the accommodation of hot food. In the refrigerators-freezers for commercial use, doors are frequently opened and closed so that food materials are put into and taken out of the compartments. Additionally, the ambient temperature is relatively higher. In view of these reasons, it should be taken into sufficient consideration that the internal temperature rises easily. As a result, a temperature drop characteristic should be considered as a returning force for the raised internal temperature.

Accordingly, a performance test is compulsory for pull down cooling. However, since the refrigeration speed largely depends upon a heat insulating housing as described above, the performance test needs to be conducted with the refrigeration units assembled to the heat insulating housing. As a result, there is a problem in that the complicated nature of the performance test cannot be overcome even with a standardized refrigeration unit.

In this embodiment, means are provided for controlling the internal temperature along a temperature curve in pull down cooling without having to depend on the specific heat insulating housing.

Describing the example as shown in FIG. 7, a control 45 is provided that includes a microcomputer and that executes a predetermined program. The control 45 is enclosed in an electrical equipment box 39 provided on an upper side of the unit mount 38. An internal temperature sensor 46, for detecting the internal temperature, is connected to the input side of the control 45.

The control 45 is provided with a clock signal generator 48 and data storage 49, which stores the straight line ‘a’ of a linear function as an ideal temperature curve in pull down cooling, as shown in FIG. 8. When the ideal curve is a linear line ‘a’, the target internal temperature drop rate (temperature change per time ΔT/Δt) is a predetermined value A irrespective of the internal temperature.

An inverter compressor 32 is connected to the input side of the control 45 via an inverter circuit 50.

Pull down control starts when the internal temperature has risen to or above a set internal temperature by a predetermined value.

As shown in FIG. 9, the actual internal temperature drop rate B is obtained at each detection-timing interval. The obtained value B is compared with a target value A read from data storage 49. When the obtained value B is equal to or below the target value A, the rotational speed of the inverter compressor 32 is increased via the inverter circuit 50. On the other hand, when the obtained value B is larger than the target value A, the rotational speed of the compressor 32 is reduced. This is repeated at predetermined time intervals so that pull down cooling is performed along the ideal curve (linear line ‘a’).

After the above-described pull down cooling, control refrigeration is carried out for refrigeration and freezing so that the internal temperature is retained at a value approximate to the previously set temperature. The following advantages can be obtained from the provision of the inverter compressor 32. In the execution of control refrigeration, the temperature drops quite slowly when the inverter compressor 32 is controlled so that the rotational speed thereof is reduced stepwise in the vicinity of the set temperature. As a result, a significantly longer continuous on time is generated for the compressor. In other words, the frequency of on-off switching is significantly reduced. Furthermore, the low-speed operation results in high efficiency and energy savings.

In the above-described case, the refrigerating performance of the low-speed operation of the inverter compressor 32 needs to be set in order to exceed an assumed standard thermal load. When the refrigerating performance cannot exceed the assumed thermal load, the internal temperature is not reduced to the set temperature but is thermally balanced, remaining at a value prior to the set temperature. When the common refrigeration unit 30, including the inverter compressor 32, is used as in this embodiment, a heat insulating housing having the highest heat invasion amount characteristic needs to be regarded as the thermal load.

Special attention is paid to the refrigerators (freezers) for commercial use so that variations in internal temperature distribution are controlled in order that food materials may be stored with a predetermined quality level. For this purpose, the refrigeration fan 23 has the function of circulating a large amount of air. Accordingly, the amount of heat generated by the electric motor of the fan is also relatively larger. When this condition is accompanied with another or other conditions such as the heat capacity of the food material, ambient temperatures, frequency of door operation and the like, a larger than expected thermal load is sometimes generated. As a result, the internal temperature may remain at a value slightly lower than the set temperature though the inverter compressor 32 is under low-speed operation, or the on-time may be rendered excessively long when a temperature drop results in a slight change.

It can be considered that there is no problem when the internal temperature remains at a value slightly lower than the set temperature. However, it is not preferable for the continued operation of the refrigerator during which the inverter compressor 32 remains in an on state. One reason for this is that frost continuously falls on the evaporator 36 due to outside air entering into the refrigerator with the opening and closing of the doors 17, or aqueous vapor emanating from food material. On the other hand, the temperature of the evaporator 36 is increased to or above 0° C. when the inverter compressor 32 is suitably turned off. Therefore, it is considered that having a suitable off time is preferable in order to maintain the heat exchanging function of the evaporator 36.

In this embodiment, energy saving is achieved by taking advantage of the use of the inverter compressor 32 in control refrigeration. With this, control means are provided to reliably afford an off time.

In short, the inverter compressor 32 is controlled in the control refrigeration range so that the internal temperature is in alignment with an ideal temperature curve, in the same manner as the in the foregoing pull down cooling range. This temperature curve is set as linear line a1 that has a gentler gradient than the ideal curve (linear line ‘a’) in pull down cooling, as shown in FIG. 10. In the case of the ideal curve a1 the internal temperature drop rate is also constant but smaller than the ideal curve ‘a’.

The ideal curve a1 is also stored in the data storage 49 and is used in the execution of a control refrigeration program that is also stored in the control 45.

Control refrigeration basically has the same manner of operation as pull down cooling. Control refrigeration starts when the internal temperature has dropped to an upper limit temperature Tu, which is higher than a set temperature To by a predetermined value. In control refrigeration, the internal temperature is detected at intervals of predetermined time periods. An actual internal temperature drop rate is obtained in parallel with the detection of the internal temperature, and thereby compared with a target value for the internal temperature drop rate. The obtained drop rate is compared with the target value (constant) for the internal temperature drop rate under an ideal temperature curve a1. When the obtained value is lower than the target value, the rotational speed of the inverter compressor 32 is increased. On the contrary, when the obtained value is larger than the target value, the rotational speed of the inverter compressor 32 is reduced. This is repeated at intervals of predetermined time periods so that the internal temperature slowly drops along an ideal curve (linear line a1).

The inverter compressor 32 is turned off when the internal temperature is reduced to a lower limit temperature, which is lower than the set temperature To by a predetermined value, whereupon the internal temperature slowly rises. When the internal temperature returns to the upper limit temperature Tu, the temperature control along the temperature curve a1 is again carried out. Thus, the procedure is repeated so that the interior is maintained about the set temperature To.

According to the control in control refrigeration, refrigeration can be accomplished with energy savings by the use of the inverter compressor 32. In addition, an off time can be reliably ensured for the inverter compressor 32. As a result, the evaporator 36 performs a defrosting function whereupon a large amount of frost can be prevented.

Therefore, for example, an operation program is provided that controls the inverter compressor 32 so that the internal temperature is in alignment with a temperature characteristic X (see FIG. 11). This includes the ideal curves ‘a’ and al from pull down cooling to control refrigeration on the refrigeration side, for example.

On the other hand, on the freezing side the set internal temperature differs from the set internal temperature of the refrigeration side, although the basic control operation at the freezing side is the same as for the refrigeration side. Furthermore, the operating time of the inverter compressor 32 is made shorter for the freezing side than for the refrigeration side so that frost formation may be prevented during control refrigeration, whereupon the ideal curve at the freezing side differs from the ideal curve at the refrigeration side. Accordingly, an operation program is necessitated that controls the inverter compressor 32 so that the internal temperature is in alignment with, for example, a temperature characteristic Y in the aforesaid figure for the freezing side.

In this embodiment, means are provided for determining whether the refrigeration unit 30 has been attached to a refrigerating compartment 15 or a freezing compartment 16. Therefore, the refrigeration or freezing operation program can control the refrigeration unit 32.

Firstly, as described above, a refrigerating operation program Px (hereinafter, “refrigeration program Px”) and a freezing operation program (hereinafter, “freezing program Py”) are prepared. The refrigeration program Px controls the inverter compressor 32 so that the internal temperature corresponds to the temperature characteristic X in FIG. 11. The freezing program Py controls the inverter compressor 32 so that the internal temperature corresponds to the temperature characteristic Y in the same figure. Each refrigeration unit 30 is provided with an equipment box 39 in which the control 45 is enclosed. Both of the above-mentioned programs Px and Py are stored in the control 45 together with the data of the ideal curves. The refrigeration program Px is usually set to be executable.

As a means for identifying the refrigerating or freezing compartment 15 or 16, a detecting portion or pressure sensor 51 is attached on the underside of a predetermined corner of the unit mount 38 of each refrigeration unit 30, coplanar with the underside of the corner, as shown in FIGS. 12 and 13. On the other hand, a detected portion or presser 52 is mounted on an upper side of the ceiling of the freezing compartment 16, so as to be located at a corner corresponding to an edge defining the opening 21. The presser 52 is biased by a spring (not shown) so as to protrude above the ceiling. No presser 52 is mounted on the upper side of the ceiling of the refrigerating compartment 15. Accordingly, the upper side of the ceiling of the refrigerating compartment 15 is flat.

The pressure sensor 51 is adapted to be elastically pressed by the presser 52, thereby switching on. The pressure sensor 51 is connected to the control 45. A selecting portion is provided in the control 45. When the pressure sensor 51 is switched off, the selecting portion selects a refrigerating program Px that is initially set, as shown in FIG. 14. Conversely, when the pressure sensor 51 is switched on, the selecting portion changes and selects a freezing program Py.

The embodiment has a structure as described above. The body 10, comprising the heat insulating housing and two standardized refrigeration units 30, separate from the body, are carried to an installation site. The refrigeration units 30 are respectively mounted in the openings 21 of the ceilings of the refrigerating and freezing compartments 15 and 16.

At the side of the freezing compartment 16, when the unit mount 38 is mounted so as to close off the opening 21, the pressure sensor 51 presses against the elastic force of the spring of the presser 52. The pressure sensor 51 receives a reaction force thereby and is switched on. At this point, the selecting portion selects the freezing program Py, as shown in FIG. 12. Conversely, at the side of the refrigerating compartment 15, the pressure sensor 51 remains switched off even after the refrigeration unit 30 has been mounted. In this case, the refrigerating program Px remains selected.

After the input of a set internal temperature and the like have been carried out with regards to each of the refrigerating and freezing compartments 15 and 16, a refrigeration operation is performed on the basis of the individual refrigerating program Px and the freezing program Py.

In the embodiment described above, the refrigeration unit 30 is made so as to be able to respectively cope with two refrigeration modes, refrigeration and freezing. The control 45 provided in the refrigeration unit 30 stores both of the refrigerating and freezing programs, Px and Py. When the refrigeration unit 30 is mounted, the control 45 identifies the refrigerating or freezing compartment 15 or 16 so that the corresponding operation program Px or Py is selected and executed.

Accordingly, the refrigeration unit 30, including the control 45, can be standardized. In addition, a number of steps in the design, production and administration can be simplified, whereupon a drastic cost reduction can be achieved.

Furthermore, identification of the refrigerating or freezing compartment 15 or 16 is automatically performed upon the mounting of the refrigeration unit 30. With this process, the corresponding operation program is then selected. As a result, there is no possibility of making the wrong choice between refrigeration and freezing, or the non-fulfillment of a choice. Moreover, since the means for identification depend on whether the pressure sensor 51 (detecting portion) provided at the side of the refrigeration unit 30 detects the presser 52 (detected portion) provided at the side of the counter, a simple construction can be employed for the identification means.

<Modified Forms>

FIGS. 15 to 17 illustrate modified forms of the identification means used in embodiment 1. In modified form las shown in FIG. 15, a reed switch 54, serving as the detecting portion, is embedded in the unit mount 38 of the refrigeration unit 30. A magnet 55, serving as the detected portion, is embedded in the ceiling of the freezing compartment 16. Upon the mounting of the refrigeration unit 30, the reed switch 54 responds to the magnet 55, thereby switching on. At that point, it is determined that the compartment is the freezing compartment.

In modified form 2 as shown in FIG. 16, a photo sensor 57 (detecting portion) is mounted in the unit mount 38 of the refrigeration unit 30. The photo sensor 57 comprises a pair of light emitting elements 58 and a pair of light detecting elements 59 disposed opposite to each other. A shading protrusion 60 (detected portion) is formed on the ceiling of the freezing compartment 16. Upon the mounting of the refrigeration unit 30, the shading protrusion 60 protrudes between the light emitting and the light detecting elements, 58 and 59, of the photo sensor 57, thereby blocking the light path. At this point, the photo sensor 57 is switched off. As a result, it is determined that the compartment is the freezing compartment 16.

Furthermore, the detected portion may be provided on the side of the refrigerating compartment 15. For example, as shown as modified form 3 in FIG. 17, a micro switch 62 (detecting portion) is mounted on the unit mount 38 of the refrigeration unit 30, whereas a recess 64 (detected portion) is formed in the ceiling of the refrigerating compartment 15.

In this example, when the refrigeration unit 30 (unit mount 38) is mounted on the side of the refrigerating compartment 15, an actuator 63 of the micro switch 62 falls into the recess 64, whereby the micro switch 62 remains switched off. As a result, the refrigerating program Px remains selected. On the other hand, when the refrigeration unit 30 (unit mount 38) is mounted on the side of the freezing compartment 16, the actuator 63 of the micro switch 62 is pressed by the flat ceiling of the refrigerating compartment 16 and is thereby switched on. At which point, the freezing program Py is selected.

### Embodiment 2

Embodiment 2 of the invention will be described with reference to FIG. 18. Information recording portions 66, each comprising a barcode, IC chip or the like, are respectively provided on edges defining the openings 21 of the refrigerating and freezing compartments 15 and 16. Signals relating to refrigeration and freezing are respectively recorded in the information recording portions 66. Readers (not shown), such as barcode readers, IC chip readers or the like, are provided and are respectively connectable to the controls 45 of the refrigeration units 30.

Accordingly, after each refrigeration unit 30 has been mounted, a refrigeration or freezing signal is read from the information-recording portion 66 provided on the heat insulating housing (compartment) and is supplied to the control 45. The refrigerating or freezing program Px or Py is selected on the basis of the supplied signal.

As in embodiment 1, the refrigerating or freezing program Px or Py may be initially set to be executable. The set program may then be left or changed to the other program on the basis of the refrigeration or freezing signal.

Incidental information relating to the refrigerating or freezing compartment 15 or 16 may also be recorded on the information recording portion 66, such as a barcode, IC chip or the like. A reader may read the information so that the information is reflected in the control of the refrigerating operation.

For example, the amount of air circulated through the compartments can be accurately determined when information is obtained about the capacity of each compartment. When the capacity is small, the amount of air can be reduced in order to achieve quietness. When the capacity is large, the amount of air can be increased so that air circulation is improved. Consequently, the refrigeration of food can be hastened or the non-uniformity in the internal temperature distribution can be reduced.

Furthermore, the production date, design circumstances, and/or the like, can be understood with information that can be identified from a product code. Accordingly, refrigeration can be carried out according to the information. For example, when a currently designed refrigeration unit 30 is mounted on a heat insulating housing that was designed five years ago, the refrigeration characteristic is compensated for on the basis of the information that a current heat insulating wall has a thickness different from a heat insulating wall produced five years ago. As a result, a more suitable control can be executed for the heat insulating housing.

Furthermore, when information is obtained about a characteristic heat invasion amount, the refrigeration characteristic can be modified according to the heat invasion amount characteristic or the control manner can be changed to a more suitable form.

Additionally, regarding the identification of the refrigerating or freezing compartment 15 or 16, the detecting portion may be provided on the side of the refrigeration unit 30. The detected portion may be provided on the side of the counter compartment as in embodiment 1 and the modified forms. Only the incidental information may be recorded on the information-recording portion 66, such as the barcodes, IC chips or the like.

### Embodiment 3

Embodiment 3 of the invention will be described with reference to FIGS. 19 and 20. In embodiment 3, a set internal temperature is utilized as a means for identifying the refrigerating or freezing compartments, 15 or 16.

Firstly, each refrigeration unit 30 includes a control 45 storing the refrigerating program Px and the freezing program Py, both with the data of their ideal curves.

Conversely, as previously described, an internal temperature (set temperature) is determined before the mounted refrigeration unit 30 is operated. For this purpose, an internal temperature-setting dial 71 is provided on an operation panel 70 (see FIG. 4) mounted on the front of the machine compartment 20. The dial 71 is capable of individually setting the set temperatures of the refrigerating and the freezing compartments and is connected to the control 45 of each refrigeration unit 30, as shown in FIG. 19.

The internal temperature-setting dial 71 can set the temperature in the refrigerating compartment 15 only in a range from −5° C. to 10° C. and set the temperature in the freezing compartment 16 only in a range from −25° C. to −10° C. Furthermore, the control 45 is provided with an identifying portion 72 and a selecting portion 73. The identifying and selecting portions 72 and 73 are operated as will be described later.

More specifically, the refrigeration units 30 are respectively mounted on the refrigerating and freezing compartments 15 and 16. Thereafter, set temperatures are individually input by internal temperature setting dials 71 as shown in FIG. 20. When an input value Tn ranges from −5° C. to 10° C., the compartment is identified as a refrigerating compartment 15. The refrigerating program Px is selected by an identification signal. On the other hand, when the input value Tn ranges from −25° C. to −10° C., the compartment is identified as a freezing compartment 16. The freezing program Py is selected by an identification signal. Subsequently, the refrigerating operation is respectively executed for the refrigerating and freezing compartments 15 and 16 on the basis of the refrigerating and freezing programs Px and Py.

In embodiment 3 as well, the refrigeration unit 30, including the control 45, can be standardized. Accordingly, a number of steps in the design, production and administration can be simplified, whereupon a drastic cost reduction can be achieved.

The identification of the refrigerating or freezing compartment 15 or 16 is automatically carried out with the required operation of setting an internal temperature. Upon this operation, the corresponding operation program is subsequently selected. As a result, there is no possibility of making the wrong choice between refrigeration and freezing, or the non-fulfillment of a choice.

### Embodiment 4

FIGS. 21 and 22 illustrate embodiment 4 of the invention. The heat insulating structure around the capillary tube 35 is improved in embodiment 4.

Embodiment 1 describes a means for overcoming the insufficiency in the flow rate in the case where the capillary tube 35, having an intermediate flow characteristic, is used in the refrigeration region. As such means, FIG. 21 shows the heat-exchange portion 40A between the capillary tube 35 and the refrigerant piping 37 at the outlet side of the evaporator 36. The heat-exchange portion 40A is set at a location nearer to the inlet. As a result, the length is increased of the part of the capillary tube 35 after the heat-exchange portion 40A. The efficiency can be improved when the heat exchanger 40 is covered with a heat insulating tube, for example. Furthermore, since dew condensation easily occurs on the part of the capillary tube 35 and accordingly results in rust or the like, the aforementioned part of the capillary tube 35 also needs to be covered with the heat insulating tube. However, a long heat insulating tube is required when the aforementioned part of the capillary tube 35 after the heat-exchange portion 40A is long.

In view of the above problem, in embodiment 4 the aforementioned part of the capillary tube 35 after the heat-exchange portion 40A is bent into a circular shape and then deformed into a flat elliptical shape, as shown in detail in FIG. 22. The flat portion 35B is arranged along the refrigerant piping 37. The flat portion 35B is covered with a heat insulating tube 75 together with the refrigerant piping 37. The heat insulating tube 75 used is minimal and dew condensation and rust can be prevented.

### Embodiment 5

Embodiment 5 of the invention will be described with reference to FIG. 23. The invention is applied to a single refrigerator or a single freezer in embodiment 5.

The refrigeration unit 30 is formed so as to contend with refrigeration modes of both refrigerating and freezing. On the other hand, the controls 45 of both refrigeration units 30 store the refrigerating and freezing programs Px and Py.

When the refrigeration unit 30 has been mounted on the body 10A of the storage cabinet, a selector switch mounted on an operation panel 70 (see FIG. 4) is switched to refrigeration or freezing depending upon whether the storage cabinet is to be used as a refrigerator or a freezer. Thereby, the corresponding operation program Px or Py is selected and is executed.

Additionally, whether the storage cabinet is to be used as a refrigerator or a freezer may be automatically determined with the mounting of the refrigeration unit 30, in the same manner as in embodiment 1. Furthermore, as in embodiment 2 the information may be read from the information-recording portion 66 provided on the body 10A, or, as in embodiment 3, a set internal temperature may be utilized.

Furthermore, when the control for driving the internal fan 25 (see FIG. 4) is changed between a refrigerator and a freezer, the control of the internal fan 25 may be switched together with the selection of the operation program Px or Py.

Furthermore, a defrosting operation is carried out as appropriate in a refrigeration storage cabinet of this type. A defrosting heater (not shown) is provided in the evaporator 36. The heater is energized by a timer or manually thereby to heat up, so that frost adherent to the evaporator 36 is melted and removed. In other words, the evaporator 36 is defrosted. Conversely, the temperature of the evaporator 36 is detected during the defrosting operation. When the detected temperature reaches a predetermined value, defrosting is regarded as completed. At this point, the defrosting operation ends and the refrigerating operation re-starts.

Refrigerators and freezers differ from each other in the set temperature of the evaporator 36 at which the defrosting is regarded as completed. Accordingly, programs for the defrosting operations of the refrigerator and the freezer are provided individually or are incorporated into the refrigerating program Px and freezing program Py. Therefore, the defrosting operation program may be switched along with the selection of the operating program Px and Py.

Furthermore, a heater 80, for the purpose of preventing dew condensation, is buried along the edge defining the opening 12 in the refrigeration storage cabinet of this type, as shown in FIG. 23. Since the refrigerator and freezer differ from each other in an internal temperature, the heaters 80 differ from each other in their capacity. However, when it is unknown whether the heater is to be used in a refrigerator or a freezer, a heater is used with a capacity corresponding to the freezing temperature range. As a result, when the refrigeration storage cabinet is used as a refrigerator, the capacity of the heater 80 is excessive. Accordingly, there is useless consumed power. Furthermore, the amount of heat invasion into the compartment is increased.

In this embodiment, on the inlet and outlet openings 12 are respectively wired both heater 80x, which has a relatively smaller capacity and is suitable for a refrigerating temperature zone, and heater 80y, which has a relatively larger capacity and is suitable for a freezing temperature zone. In coordination with the selection of the foregoing operation program Px or Py, the heater 80x or 80y Lu be operated is selected via a switch relay 81. Consequently, power consumption is reduced to a minimum level and the invasion of unnecessary heat into the compartment is restrained. Additionally, dew condensation can be reliably prevented on the edges defining the inlet and outlet openings 12.

<Modified Forms>

FIG. 25 illustrates a modified form of means for changing the capacity of the dew-condensation preventing heater between refrigeration and freezing. Only a heater 80 with a capacity suitable for the freezing temperature zone is used. In addition, a diode 83 and a switching relay 84 are connected in parallel to each other and are connected to the heater 80.

The switching relay 84 is opened and closed in synchronization with the selection of the aforementioned operation program Px or Py. In the freezing temperature zone, the relay 84 is closed so that the diode 83 is short-circuited, whereupon the total capacity of the heater 80 is used. Conversely, for a refrigerating temperature zone, the relay 84 is opened so that half-wave rectification is carried out by the diode 83, whereby the capacity of the heater 80 is reduced.

### Embodiment 6

FIG. 26 illustrates embodiment 6 of the invention. Embodiment 6 shows another example of control in pull down cooling. A plurality of target temperature curves in pull down cooling is stored. A temperature curve is selected on the basis of the difference between the set internal temperature and a current internal temperature. This example is effectively used as a recovering means for a transient temperature rise during control refrigeration.

For example, the internal temperature can rise to a large degree when the door is frequently opened and closed or when warm foodstuff is put into a compartment of the refrigerator during the operation in a control refrigeration range. In this case, the refrigerator is switched from the control refrigeration range to a pull down cooling range in the foregoing embodiment 1, so that the target temperature curve also changes to a curve (a) with a larger temperature drop. As a result, the internal temperature usually recovers quickly.

However, when an internal temperature is significantly higher than a set value (3° C.), for example, at 10° C. (the difference is 7° C.), the temperature is said to be unsuitable for the preservation of food materials. The internal temperature may be significantly higher due to reasons such as the door being excessively opened and closed per period of time, a large amount of food materials are brought into the compartment, or the temperature of the stored food material is high.

On this account, when the internal temperature rises to be higher by 7° C., for example, than the set internal temperature (3° C.), a normal temperature curve for pull down cooling a(x) is not employed. Instead, another temperature curve a(y) is employed that has a temperature drop ratio of 1.5 to 3 times as large as the normal temperature curve, as shown in FIG. 26. The operation is controlled according to the temperature a (y). As a result, the normal temperature can quickly be recovered. In this case, when the temperature is recovered and reaches the control refrigeration range, the temperature curve a1 for control is re-used. At this point, the temperature curve a(y), with the high temperature drop ratio, is canceled.

Thus, the foregoing arrangement is effective when a return to the normal temperature is desired under the conditions in which the internal temperature is shifted to a large degree from the control refrigeration range.

### Other Embodiments

The present invention should not be limited to the embodiments described above with reference to the accompanying drawings. For example, the technical scope of the invention encompasses the following embodiments. Furthermore, the invention can be modified in practice in addition to the following without departing from the scope thereof.

(1) The detected portion constituting the identifying means in embodiment 1 may be provided on either a refrigerating or a freezing compartment, although the arrangement is partially exemplified as a modified form.

(2) Regarding embodiment 3 as well, the information recording portion recording the incidental information about the refrigerating or freezing compartment may be separately provided in embodiment 3.

(3) The foregoing embodiments exemplify the case where the inverter compressor is used as a means for adjusting the refrigerating performance of the refrigeration unit. However, the invention should not be limited to this case. Compressors may be used which have an unload function, adjusting the number of operated cylinders according to the load in a multiple of cylinders. Another capacity-variable compressor may be used. Furthermore, a refrigeration unit with a high refrigerating performance may be provided, whereas a bypass circuit from the high-pressure side to the low-pressure side may also be provided. In this case, a bypass circuit from the high-pressure side to the low-pressure side may be provided and a bypass valve may be closed during the freezing mode. The bypass valve is opened during the refrigerating operation so that the refrigerating performance is reduced.

(4) For standardization of an expanding mechanism, a thermostatic expansion valve with a large variable flow-rate may be used. Furthermore, an electronic expansion valve may also be used.

(5) For example, there is a case where a refrigeration unit may have the same refrigerating performance depending upon the interrelationship between the refrigeration unit and the capacity of a heat-insulating housing to which the unit is to be mounted, even though the refrigeration unit can be used for both refrigeration and freezing. In this case, a constant-speed compressor may be used instead of the inverter compressor. The technical scope of the invention encompasses such use of a constant-speed compressor.

(6) The invention may be applied to a single refrigerator or a single freezer as exemplified in embodiment 5. The invention may also be applied to refrigerators-freezers with other capacity ratios and the like.

(7) The type of refrigeration specification should not be limited to the above-described refrigeration and freezing, but may include others such as constant-temperature high-humidity refrigeration and freezing and so on. Furthermore, one and the same refrigerator may be used for three or more refrigeration specifications to be determined.

(8) The refrigeration unit may or may not be detachably attachable to the body, such as the heat insulating housing. The refrigeration unit may be incorporated into the body. Components of the refrigeration unit may not be assembled into an inseparable state. For example, components of the evaporator and the like may be replaceable. The refrigeration unit of this invention includes such a type.

(9) A dedicated manually operated selector switch may be provided for switching the refrigerating and freezing programs.

(10) In the foregoing embodiments, a variation of the internal temperature with the passage of time is exemplified as a refrigeration characteristic composing the operation program. Standards at the refrigerating device side may be used, for example, a variation of the low pressure of refrigerant or the evaporation temperature with the passage of time.

(11) At the side of control refrigeration, too, a plurality of refrigerating characteristics may be provided, and one of the characteristics may selectively be read out according to conditions or the like.

(12) Furthermore, all of the programs may be stored in the control during the production of refrigeration storage cabinets. A specific program or programs may be designated to be executable when the refrigeration storage cabinets are shipped or until the refrigeration storage cabinets are operated.

(13) Furthermore, a predetermined single program may be stored in the control.

(14) The invention should not be limited to the refrigeration storage cabinet as exemplified above, but may be applicable to other refrigeration apparatuses. For example, food service carts are exemplified. When the refrigeration unit is provided for the refrigeration of a refrigerating compartment of a food service cart, the refrigerating performance needs to vary according to the capacity of the refrigerating compartment or according to the load brought into the refrigerating compartment. In this case, a common or standardized refrigeration unit is made with a wide range of refrigerating performance. The refrigerating performance and an operation program are selected according to an object. As one structure, for example, a freezing apparatus such as a compressor, condenser, and the like, is mounted on an outer surface of the body. In addition, an evaporator is disposed in a space communicating with the refrigerating compartment.

(15) The invention may be applied to ice-makers. In ice-makers, the refrigerating performance needs vary according to the capacity of an ice storage cabinet, the amount of ice made, or the load brought into the compartment. In this case, too, a common or standardized refrigeration unit should be provided with a wide range of refrigerating performance. A refrigerating performance and an operation program are selected according to the specification, such as the capacity of the ice storage cabinet or the amount of ice made. A freezing apparatus of the refrigeration unit is mounted on an outer surface of the ice storage cabinet. An evaporator is disposed in the ice making section.

(16) The invention may further be applied to beer servers. Beer servers are roughly divided into an air-cooled type, in which a beer tank is brought into the refrigerator in order for the beer to be refrigerated, and an instantaneous cooling type, in which beer is caused to flow through piping provided in chilled water. In each type, the refrigerating performance needs to be varied according to the amount of beer fed per unit of time. Accordingly, in this case as well, a common or standardized refrigeration unit should be provided with a wide range of refrigerating performance. A refrigerating performance and an operation program are selected according to the specification, such as the amount of beer fed per unit of time or the like.

In the air-cooled type, the freezing apparatus of the refrigeration unit is disposed on an upper or lower side of the refrigerator. The evaporator is disposed in the cabinet. In the instantaneous cooling type, the freezing apparatus of the refrigeration unit is disposed on an upper or lower side of a chilled water tank. The evaporator is disposed in the chilled water tank so that the ice is made around the evaporator.

1-12. (canceled)

13. Refrigeration equipment characterized by a refrigeration unit that includes a compressor, a condenser, an expanding mechanism, and an evaporator, and comprising:
a control means storing one of a plurality of refrigerating specifications;
wherein the refrigeration equipment is able to operate according to any of the plurality of refrigerating specifications.

14. The refrigeration equipment according to claim 13, characterized in that the control means stores the plurality of refrigerating specifications;
wherein the control means selects an appropriate one of the plurality of refrigerating specifications; and
wherein the refrigerating equipment is operated according to the appropriate one of the plurality of refrigerating specifications.

15. A refrigerating storage cabinet in which a heat insulating housing contains a refrigeration unit that includes a compressor, a condenser, an expanding mechanism, and an evaporator and comprising:
a control means storing one of a plurality of refrigerating specifications;
wherein the refrigerating unit is able to operate according to any of the plurality of refrigerating specifications stored in the control means.

16. The refrigerating storage cabinet according to claim 15, characterized in that the control means stores the plurality of refrigerating specifications;
wherein the control device selects an appropriate one of the plurality of refrigerating specifications; and
wherein the refrigerating unit is operated according to the appropriate one of the plurality of refrigerating specifications.

17. The refrigerating storage cabinet according to claim 16, characterized in that the heat insulating housing comprises:
a condensation-preventing heater with variable heating performance located about an opening of the heat insulated housing;
a switching device provided to switch the variable heating performance of the heater to correspond to the appropriate one of the plurality of refrigerating specifications.

18. The refrigerating storage cabinet according to claim 17, characterized in that the refrigeration unit is detachably attachable to the heat insulating housing;
wherein the refrigerating storage cabinet comprises:
an identifying means for identifying the refrigerating specification of the heat insulating housing to which the refrigeration unit is detachably attached;
wherein the control means selects and executes the appropriate one of the plurality of refrigerating specifications based on an identification signal from the identifying means.

19. The refrigerating storage cabinet according to claim 18, wherein the identifying means includes:
a detecting portion provided on one of the refrigeration unit or the heat insulating housing;
a detected portion provided on an other of the heat insulated housing or the refrigeration unit;
wherein an interaction between the detecting portion and the detected portion determines the identification signal.

20. The refrigerating storage cabinet according to claim 18, characterized in that the identifying means comprises:
a set internal temperature input section for inputting a set internal temperature for the heat-insulating housing;
wherein the identifying means determines the appropriate one of the plurality of refrigerating specifications based on the set internal temperature.

21. The refrigerating storage cabinet according to claim 18, characterized in that the identifying means comprises:
a signal recording section provided with the heat insulating housing for storing an identification signal for selecting the appropriate one of the plurality of refrigerating specifications; and
a reading section that is capable of reading the identification signal of the signal recording section and communicating the identification signal to the control means.

22. The refrigerating storage cabinet according to claim 18, wherein the heat insulating housing comprises:
an information recording section storing supplementary information; and
information conveying means for reading and communicating the supplementary information to the control means;
wherein the supplementary information includes at least one of a size of the heat insulating housing or a heat invasion amount characteristic.

23. The refrigerating storage cabinet according to claim 16, characterized in that the plurality of refrigerating specifications includes:
a refrigerating specification for refrigeration; and
a refrigerating specification for freezing.

24. The refrigerating storage cabinet according to claim 15, characterized in that:
the refrigerating unit performs a pull down cooling when an internal temperature is higher than an upper limit temperature until the internal temperature drops to the upper limit temperature;
wherein the upper limit temperature is higher than a predetermined temperature by a predetermined value;
the refrigerating unit performs a control refrigeration when the internal temperature is at the upper limit temperature higher until the internal temperature drops to a lower limit temperature, after which the refrigerating unit is stopped, allowing the internal temperature to rise;
wherein the lower limit temperature is below the predetermined temperature by a predetermined amount;
wherein the control refrigeration is repeated, maintaining the internal temperature about the predetermined temperature;
at least one of a plurality of pull down cooling characteristics or a plurality of control refrigeration characteristics are provided for controlling the refrigeration unit during the respective pull down cooling and control refrigeration;
an appropriate one of the at least one of the plurality of pull down cooling characteristics is selected based upon conditions of the refrigerating storage cabinet; and
an appropriate one of the at least one of the plurality of control refrigeration characteristics is selected based upon the conditions of the refrigerating storage cabinet.

25. A refrigerating storage cabinet in which a heat insulating housing comprises a refrigeration unit that includes a compressor, a condenser, an expanding mechanism, and an evaporator, and comprising:
a control means storing a plurality of refrigerating specifications;
a detecting portion on one of the heat insulated housing or the refrigerating unit;
a detected portion on an other of the heat insulated housings or the refrigerating unit;
wherein the control device selects an appropriate one of the plurality of refrigerating specifications based upon an interaction between the detecting portion and the detected portion;
wherein the refrigerating unit is operated according to the appropriate one of the plurality of refrigerating specifications.

26. The refrigerating storage cabinet according to claim 25, characterized in that the heat insulating housing comprises:
a condensation-preventing heater operable at a plurality of heating performance levels located about an opening of the heat insulated housing;
a switching device provided to operate the condensation-preventing heater at an appropriate one of the plurality of heating performance levels based upon the interaction between the detecting portion and the detected portion.

27. The refrigerating storage cabinet according to claim 26, characterized in that the plurality of refrigerating specifications includes:
refrigeration; and
freezing.
